(19) United States
(12) Patent Application Publication
(10) Pub. No.: US 2019/0088187 A1
(43) Pub. Date: Mar. 21, 2019

(54) DRIVING METHODS AND DRIVING DEVICES OF DISPLAY DEVICES, AND DISPLAY DEVICES

(71) Applicant: Wuhan China Star Optoelectronics Technology Co., Ltd., Wuhan, Hubei (CN)

(72) Inventor: Weinan YAN, Shenzhen, Guangdong (CN)

(73) Assignee: Wuhan China Star Optoelectronics Technology Co., L td., Wuhan, Hubei (CN)

(21) Appl. No.: 15/534,624

(22) PCT Filed: Apr. 27, 2017
(86) PCT No.: PCT/CN2017/082113

§ 371 Date: Jun. 9, 2017

(30) Foreign Application Priority Data
Apr. 11, 2017 (CN) 201710230814.8

(51) Int. Cl. G09G 3/20

(52) U.S. Cl. CPC G09G 3/2074; G09G 2330/021; G09G 2320/0626; G09G 2310/027

(57) ABSTRACT

The present disclosure provides a driving method and a driving device of display devices. The driving device includes an image input unit, an image analyzing unit, an image processing unit, and an image output unit. The image input unit receives image data of each frames to be displayed in sequence. The image analyzing unit divides the received image data of the frame into a plurality of display areas, and calculates pixel grayscale values of the display areas to determine adjustment coefficients of each of the display areas to lower down the pixel grayscale values of the display areas. The image processing unit combines all of the display areas after adjusting the pixel grayscale values to form driving data of the current frame. The image output unit 40 outputs the driving data of the current frame to drive the current frame to be displayed.

### BACKGROUND OF THE INVENTION

### 1. Field of the Invention

The present disclosure relates to a display technology, and more particularly to a driving method and a driving device of a display.

### 2. Discussion of the Related Art

A tablet display device has multiple advantages, such as a thin body, power saving, and radiation-free, and tablet display device has been widely used. A conventional tablet display device may be a Liquid Crystal Display (LCD) or a Organic Light Emitting Display (OLED). With development of display technology and improvement of user needs, requirements for a display design and display are getting higher and higher. Further, with improvement of display effect of the display, corresponding problems also arise. One of the corresponding problems is a power consumption problem. For mobile phones, tablet computer, and terminals to rely on batteries, the power consumption problem is more important.

### SUMMARY

In view of the shortcomings of the traditional technology, the present disclosure provide a driving method and a driving device of a display to reduce power consumption of the display.

To achieve the foregoing purpose, the present disclosure adopts the following technical scheme:

A driving method of display devices, includes:

dividing received image data of a frame into a plurality of display areas;

respectively adjusting pixel grayscale values of each of the display areas of the current frame to reduce the pixel grayscale values of some of the or all of the display areas;

combining all of the display areas after adjusting the pixel grayscale values to form driving data of the current frame; and

outputting the driving data of the current frame to drive the current frame to be displayed.

The driving method further includes:

setting all of sub-pixels of a n-th display area of the current frame as a set;

calculating an average value Gₐ(n) of the grayscale values in the set;

calculating a variance Gᵥ(n) of the grayscale values in the set;

calculating a root-mean-square-error R(n) of the grayscale value of the current frame being relative to the grayscale value of the driving data of a pervious frame;

when Gₐ(n)≥Gₐₜₕ, Gᵥ(n)≥Gᵥₜₕ, and R(n)≥Rₜₕ, reducing the pixel grayscale values of the n-th display area;

wherein the Gₐₜₕ is a threshold of the average value of the grayscale values;

wherein the Gᵥₜₕ is a threshold of the variance of the grayscale values;

wherein the Rₜₕ is a threshold of the root-mean-square-error of the grayscale values;

wherein n is a positive integer;

wherein when the current frame is the first frame being inputted, the grayscale value of the driving data of a pervious frame is set as 0.

The driving method further includes:

adjusting the pixel grayscale value of the n-th display area by the following formula:

G′ₚ(n)=f(n)×Gₚ(n);

wherein the Gₚ(n) is the pixel grayscale value before adjustment;

wherein the G′ₚ(n) is the pixel grayscale value after adjustment;

wherein the f(n) is an adjustment coefficient of the n-th display area;

wherein when Gₐ(n)≥Gₐₜₕ, Gᵥ(n)≥G_{yth}, and R(n)≥Rₜₕ, 0<f(n)<1; otherwise f(n)=1.

The driving method further includes:

setting an adjustment threshold ΔG₀;

when a grayscale value difference ΔG=Gₚ(n)−f(n)×Gₚ(n)>ΔG₀, calculating the G′ₚ(n) by the following formula:

G′ₚ(n)=Gₚ(n)−ΔG₀.

The display areas includes:

a central area, located on a central position of a displayed image;

a plurality of rim areas, located around the central area;

wherein a dimension of the central area is more than 50% of the dimension of the displayed image.

The present disclosure further provides a driving device of display devices, includes:

an image input unit, configured to receive image data of each frames to be displayed in sequence;

an image analyzing unit, configured to divide the received image data of the frame into a plurality of display areas, and calculate pixel grayscale values of the display areas to determine adjustment coefficients of each of the display areas; wherein the adjustment coefficients of some of the or all of the display areas are configured to lower down the pixel grayscale values of the display areas;

an image processing unit, configured to adjust the pixel grayscale values of the display areas of a current frame according to the adjustment coefficients determined by the image analyzing unit, and combine all of the display areas after adjusting the pixel grayscale values to form driving data of the current frame;

an image output unit, configured to output the driving data of the current frame to drive the current frame to be displayed.

The image analyzing unit includes:

a data saving module, configured to save a threshold of the average value of the grayscale values Gₐₜₕ, a threshold of the variance of the grayscale values Gᵥₜₕ, a threshold of the root-mean-square-error of the grayscale values Rₜₕ, and the driving data of a pervious frame;

an analyzing module, configured to divide the received image data of the frame into the plurality display areas, set all of sub-pixels of a n-th display area of the current frame as a set, calculate an average value Gₐ(n) of the grayscale values in the set, calculate a variance Gᵥ(n) of the grayscale values in the set, calculate a root-mean-square-error R(n) of the grayscale value of the current frame being relative to the grayscale value of the driving data of a pervious frame, and determine an adjustment coefficient f(n) of the n-th display area by comparing calculation values and thresholds; wherein n is a positive integer;

wherein when Gₐ(n)≥Gₐₜₕ, Gᵥ(n)≥Gᵥₜₕ, and R(n)≥Rₜₕ, the f(n) is determined to reduce the pixel grayscale value of the n-th display area;

wherein when the current frame is the first frame being inputted, the grayscale value of the driving data of a pervious frame saved in the data saving module is set as 0.

The image processing unit adjusts the pixel grayscale value of the n-th display area by the following formula:

G′ₚ(n)=f(n)×Gₚ(n);

wherein the Gₚ(n) is the pixel grayscale value before adjustment, the G′ₚ(n) is the pixel grayscale value after adjustment, and the f(n) is an adjustment coefficient of the n-th display area;

wherein when Gₐ(n)≥Gₐₜₕ, Gᵥ(n)≥Gᵥₜₕ, and R(n)≥Rₜₕ, 0<f(n)<1; otherwise f(n)=1.

The image processing unit sets an adjustment threshold ΔG₀;

wherein when a grayscale value difference ΔG=Gₚ(n)−f(n)×Gₚ(n)>ΔG₀, the image processing unit calculates the G′ₚ(n) by the following formula:

G′ₚ(n)=Gₚ(n)−ΔG₀.

The display areas includes:

a central area, located on a central position of a displayed image;

a plurality of rim areas, located around the central area;

wherein a dimension of the central area is more than 50% of the dimension of the displayed image.

Compared to the prior art, the preset disclosure provides the driving method and the driving device of the display devices. Since the received image data of the frame is divided into the multiple display areas and the pixel grayscale values of each of the display areas of the current frame are adjusted, the pixel grayscale values of some of the or all of the display areas are reduced. In other words, luminance of some of particular area is reduced. Therefore, the power consumption is reduced.

In a specific example, the pixel grayscale values are respectively calculated. When an average value of the grayscale values, a variance of the grayscale values, and a root-mean-square-error of the grayscale value of the current frame being relative to the grayscale value of the driving data of a previous frame of one of the display areas are respectively greater than thresholds, the grayscale values of the sub-pixels of the one of the display areas are respectively adjusted by the downgrade adjustment. The luminance of some of the or all of the display areas is selectively reduced while the image observed by the human eye is not affected, and the power consumption is reduced.

### BRIEF DESCRIPTION OF THE DRAWINGS

FIG. 1 is a flowchart of a driving method of display devices provided in one embodiment of the present disclosure;

FIG. 2 is a schematic view of dividing a frame into multiple display areas provided in one embodiment of the present disclosure;

FIG. 3 is a schematic view of a driving device of display devices provided in one embodiment of the present disclosure;

FIG. 4 is a schematic view of a display device provided in one embodiment of the present disclosure.

### DETAILED DESCRIPTION OF THE EMBODIMENTS

Embodiments of the invention will now be described more fully hereinafter with reference to the accompanying drawings, in which embodiments of the invention are shown.

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of the invention result in confusion, well-known structures may be omitted and/or functions described in unnecessary detail.

An embodiment of the present disclosure provides a driving method of display devices, and the driving method includes:

1. dividing received image data of a frame into a plurality of display areas;

Specifically, the frame to be displayed may be divided into multiple display areas with a same dimension. However, the frame to be displayed may be divided into multiple display areas with different dimensions. Since humans are more concerned about a central area of an image, a dimension of the central area may be greater than dimensions of the other areas of the image. Further, dimensions of rim areas of the image may be smaller than dimensions of the other areas of the image.

2. respectively adjusting pixel grayscale values of each of the display areas of the current frame to reduce the pixel grayscale values of some of the or all of the display areas;

First of all, the pixel grayscale values are respectively calculated. When some of the display areas meet a reduced order condition, the pixel grayscale values of the display areas that meet the reduced order condition may be reduced.

3. combining all of the display areas after adjusting the pixel grayscale values to form driving data of the current frame, and outputting the driving data of the current frame to drive the current frame to be displayed.

Therefore, luminance of some of the or all of the display areas may be reduced, and power consumption of the display device may also be reduced.

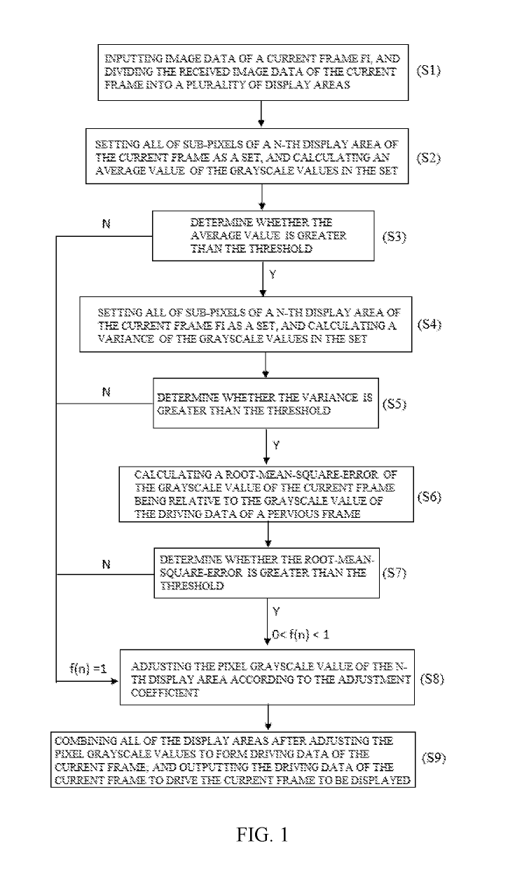

Specifically, with reference to FIG. 1, the driving method includes the steps of:

S1: inputting image data of a current frame Fi, and dividing the received image data of the current frame into a plurality of display areas;

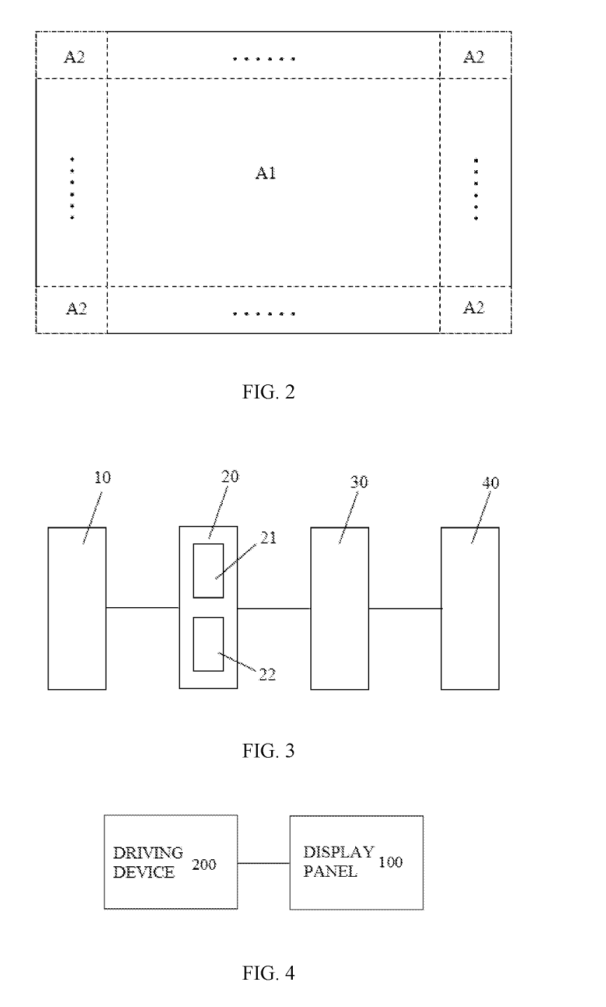

With reference to FIG. 2, in the embodiment, a display image is divided into a central area A1 and a plurality of rim areas A2. The central area A1 is located on the display image, and the rim areas A2 are located around the central area A1. A dimension of the central area A1 is greater than dimensions of the rim areas A2, and the dimensions of the rim areas A2 are the same. However, in the other embodiment, the dimensions of the rim areas A2 may be different.

S2: setting all of sub-pixels of a n-th display area of the current frame Fi as a set, and calculating an average value Gₐ(n) of the grayscale values in the set;

The average value Gₐ(n) may be calculated by the following formula (1). In the formula (1), G_{Pj}(n) is a grayscale value of the j-th sub-pixel of the n-th display area, and J(n) is a number of the mount of the sub-pixels in the n-th display area.

$${G}_{a} ( n ) = \frac{{\sum }_{j = 1}^{J} {G}_{Pj} ( n )}{J ( n )} ; \qquad ( 1 )$$

S3: comparing the average value Gₐ(n) with a threshold Gₐₜₕ of the average value of the grayscale values to determine whether the average value Gₐ(n) is greater than the threshold Gₐₜₕ. When the average value Gₐ(n) is greater than the threshold Gₐₜₕ (Gₐ(n)≥Gₐₜₕ), step S4 may be continuously implemented. When the average value Gₐ(n) is not greater than the threshold Gₐₜₕ(Gₐ(n)<Gₐₜₕ), an adjustment coefficient f(n) of the n-th display area of the current frame may be 1 (f(n)=1)

S4: setting all of sub-pixels of a n-th display area of the current frame Fi as a set, and calculating a variance Gᵥ(n) of the grayscale values in the set;

The variance Gᵥ(n) may be calculated by the following formula (2). In the formula (2), G_{Pj}(n) is a grayscale value of the j-th sub-pixel of the n-th display area, J(n) is a number of the mount of the sub-pixels in the n-th display area, and Gₐ(n) is the average value of the grayscale values in the set.

$${G}_{v} ( n ) = \sqrt{\frac{{\sum }_{j = 1}^{J} {[ {G}_{Pj} ( n ) - {G}_{a} ( n ) ]}^{2}}{J ( n )}} ; \qquad ( 2 )$$

S5: comparing the variance Gᵥ(n) with a threshold Gᵥₜₕ of the variance of the grayscale values to determine whether the variance Gᵥ(n) is greater than the threshold Gᵥₜₕ. When the variance Gᵥ(n) is greater than the threshold Gᵥₜₕ(Gᵥ(n)≥Gᵥₜₕ), step S6 may be continuously implemented. When the variance Gᵥ(n) is not greater than the threshold Gᵥₜₕ(Gᵥ(n)<Gᵥₜₕ), the adjustment coefficient f(n) of the n-th display area of the current frame may be 1(f(n)=1).

S6: setting all of sub-pixels of a n-th display area of the current frame Fi as a set, and calculating a root-mean-square-error R(n) of the grayscale value of the current frame Fi being relative to the grayscale value of the driving data of a pervious frame Fi−1;

The root-mean-square-error R(n) may be calculated by the following formula (3). In the formula (3), G_{Pj}(n, Fᵢ) is a grayscale value of the j-th sub-pixel of the n-th display area of the current frame Fi, G_{Pj}(n, Fᵢ₋₁) is a grayscale value of the j-th sub-pixel of the n-th display area of the current frame Fi−1, and J(n) is a number of the mount of the sub-pixels in the n-th display area.

$$R ( n ) = \sqrt{\frac{{\sum }_{j = 1}^{J} {[ {G}_{Pj} ( n , {F}_{i} ) - {G}_{Pj} ( n , {F}_{i - 1} ) ]}^{2}}{J ( n )}} ; \qquad ( 3 )$$

S7: comparing the root-mean-square-error R(n) with a threshold Rₜₕ of the root-mean-square-error of the grayscale values to determine whether the root-mean-square-error R(n) is greater than the threshold Rₜₕ. When the root-mean-square-error R(n) is greater than the threshold Rₜₕ(R(n)≥Rₜₕ), the adjustment coefficient f(n) of the n-th display area of the current frame may between 0 and 1 (0<f(n)<1) and the adjustment coefficient f(n) may be a constant or an inversely proportional function related to the average value Gₐ(n). When the adjustment coefficient f(n) is not greater than the threshold Rₜₕ(R(n)<Rₜₕ), the adjustment coefficient f(n) of the n-th display area of the current frame may be 1(f(n)=1).

S8: adjusting the pixel grayscale value of the n-th display area according to the adjustment coefficient f(n);

The pixel grayscale value of the n-th display area may be adjusted by the following formula:

G′ₚ(n)=f(n)×Gₚ(n);

In the above formula, Gₚ(n) is the pixel grayscale value of the n-th display area before adjustment, G′ₚ(n) is the pixel grayscale value of the n-th display area after adjustment, f(n) is an adjustment coefficient of the n-th display area. The pixel grayscale value G′ₚ(n) of the n-th display area after adjustment is determined by multiplying the pixel grayscale value Gₚ(n) of the n-th display area before adjustment by the adjustment coefficient f(n).

S9: combining all of the display areas after adjusting the pixel grayscale values to form driving data of the current frame; and outputting the driving data of the current frame Fi to drive the current frame Fi to be displayed.

The above mentioned n, i, j, each are positive integer. Further, when the current frame Fi is the first frame being inputted (i=1), the grayscale value of the driving data of a pervious frame is set as 0.

In the driving method, when Gₐ(n)≥Gₐₜₕ, Gᵥ(n)≥Gᵥₜₕ, and R(n)≥Rₜₕ, determining 0<f(n)<1 to reduce the pixel grayscale values of the n-th display area; otherwise f(n)=1 to maintain the pixel grayscale values of the n-th display area.

When Gₐ(n)≥Gₐₜₕ and Gᵥ(n)≥Gᵥₜₕ, the pixel grayscale values are greater, the grayscale values are adjusted by the downgrade adjustment to reduce influence of the image. When R(n)≥Rₜₕ, the current frame Fi and a pervious frame Fi−1 are very different. When the current frame Fi and a pervious frame Fi−1 are very different, human eye may not obviously sense brightness change. Therefore, the grayscale values are adjusted by the downgrade adjustment to reduce the influence of the image.

When the three conditions, Gₐ(n)≥Gₐₜₕ, Gᵥ(n)≥Gᵥₜₕ, and R(n)≥Rₜₕ, are maintained, the grayscale values are adjusted by the downgrade adjustment. Therefore, the steps S3, S5, and S7 may be performed in any order. In the other words, Gₐ(n) may be calculated and compared at first, Gᵥ(n) may be calculated and compared at first, or R(n) may be calculated and compared at first f(n) may be acquired with the same value. The calculation of Gₐ(n) and Gᵥ(n) may be easier than the calculation of R(n). Therefore, when one of the conditions Gₐ(n)≥Gₐₜₕ and Gᵥ(n)≥Gᵥₜₕ may not meet the requirement to be adjusted by the downgrade adjustment, R(n) may not be calculated. Parameters in calculation of Gᵥ(n) may include Gₐ(n). Therefore, Gₐ(n) may be calculated and compared at first, Gᵥ(n) may be calculated and compared at second, and R(n) may be calculated and compared finally.

In step S8, to avoid the influence of the image caused by a grayscale value difference, an adjustment threshold ΔG₀ is set. When the grayscale value difference ΔG=Gₚ(n)−f(n)×Gₚ(n)>ΔG₀, calculating the G′ₚ(n) by the following formula

G′ₚ(n)=Gₚ(n)−ΔG₀.

Since people have a high degree of attention to a central area of the image, when a dynamic image is displayed, the grayscale of the image rim area may not affect a perception of a user. Therefore, the dimension of the central area A1 is greater than dimensions of the rim areas A2. The greater dimension of an area, the smaller probability to simultaneously achieve Gₐ(n)≥Gₐₜₕ, Gᵥ(n)≥Gᵥₜₕ, and R(n)≥Rₜₕ, and vice versa. Therefore, the probability to adjust the central area A1 by the downgrade adjustment is smaller, and the probability to adjust the rim areas A2 by the downgrade adjustment is greater. In the embodiment, the dimension of the central area A1 is more than 50% of the dimension of the displayed image.

The present disclosure further provides a driving device of display devices. With reference to FIG. 3, and the driving device includes an image input unit 10, an image analyzing unit 20, an image processing unit 30, and an image output unit 40. The driving device executes the driving method to drive a display panel to display an image.

The image input unit 10 receives image data of each frames to be displayed in sequence. The image analyzing unit 20 divides the received image data of the frame into a plurality of display areas, and calculates pixel grayscale values of the display areas to determine adjustment coefficients of each of the display areas. The adjustment coefficients of some of the or all of the display areas are configured to lower down the pixel grayscale values of the display areas. The image processing unit 30 adjusts the pixel grayscale values of the display areas of a current frame according to the adjustment coefficients determined by the image analyzing unit, and combines all of the display areas after adjusting the pixel grayscale values to form driving data of the current frame. The image output unit 40 outputs the driving data of the current frame to drive the current frame to be displayed.

The image analyzing unit 20 includes a data saving module 21 and an analyzing module 22. The data saving module 21 saves a threshold of the average value of the grayscale values Gₐₜₕ, a threshold of the variance of the grayscale values Gᵥₜₕ, a threshold of the root-mean-square-error of the grayscale values Rₜₕ, and the driving data of a pervious frame. The analyzing module 22 divides the received image data of the frame into the plurality display areas, sets all of sub-pixels of a n-th display area of the current frame as a set, calculate an average value Gₐ(n) of the grayscale values in the set, calculates a variance Gᵥ(n) of the grayscale values in the set, calculates a root-mean-square-error R(n) of the grayscale value of the current frame being relative to the grayscale value of the driving data of a pervious frame, and determines an adjustment coefficient f(n) of the n-th display area by comparing calculation values and thresholds. When Gₐ(n)≥Gₐₜₕ, Gᵥ(n)≥Gᵥₜₕ, and R(n)≥Rₜₕ, the f(n) is determined to reduce the pixel grayscale value of the n-th display area.

When the current frame is the first frame being inputted, the grayscale value of the driving data of a pervious frame saved in the data saving module 21 is set as 0.

The image processing unit 30 adjusts the pixel grayscale value of the n-th display area by the following formula:

G′ₚ(n)=f(n)×Gₚ(n).

The Gₚ(n) is the pixel grayscale value before adjustment, the G′ₚ(n) is the pixel grayscale value after adjustment, and the f(n) is an adjustment coefficient of the n-th display area.

The image processing unit 30 combines the pixel grayscale values of all of the display area after adjustment to form the driving data of the current frame. The image processing unit 30 outputs the driving data to the image output unit 40 to drive the current frame to be displayed, and saves the driving data into the data saving module 21.

The image processing unit 30 sets an adjustment threshold ΔG₀, when a grayscale value difference ΔG=Gₚ(n)−f(n)×Gₚ(n)>ΔG₀, the image processing unit calculates the G′ₚ(n) by the following formula:

G′ₚ(n)=Gₚ(n)−ΔG₀.

The present disclosure further provides a display device. With reference to FIG. 4, the display device includes a driving device 200 and a display panel 100. The driving device 200 provides driving signals to the display panel 100 to drive the display panel 100 to display image. The driving device 200 is the driving device mentioned in the above embodiment. The display device may be a LCD or an OLED.

As shown in the above mentioned driving method and driving device provided in the embodiment, the pixel grayscale values are respectively calculated. When an average value of the grayscale values, a variance of the grayscale values, and a root-mean-square-error of the grayscale value of the current frame being relative to the grayscale value of the driving data of a pervious frame of one of the display areas are respectively greater than thresholds, the grayscale values of the sub-pixels of the one of the display areas are respectively adjusted by the downgrade adjustment. The luminance of some of the or all of the display areas is selectively reduced while the image observed by the human eye is not affected, and the power consumption is reduced

As shown in the above mentioned driving method and driving device provided in the embodiment, when the display device is an OLED display, not only the power consumption may be reduced, but also the life time of the OLED may be extended.

It should be noted that the relational terms herein, such as “first” and “second”, are used only for differentiating one entity or operation, from another entity or operation, which, however do not necessarily require or imply that there should be any real relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A driving method of display devices, comprising:
dividing received image data of a frame into a plurality of display areas;
respectively adjusting pixel grayscale values of each of the display areas of the current frame to reduce the pixel grayscale values of some of the or all of the display areas;
combining all of the display areas after adjusting the pixel grayscale values to form driving data of the current frame; and
outputting the driving data of the current frame to drive the current frame to be displayed.

2. The driving method of the display as claimed in claim 1, further comprising:
setting all of sup-pixels of a n-th display area of the current frame as a set;
calculating an average value Gₐ(n) of the grayscale values in the set;
calculating a variance Gᵥ(n) of the grayscale values in the set;
calculating a root-mean-square-error R(n) of the grayscale value of the current frame being relative to the grayscale value of the driving data of a pervious frame;
when Gₐ(n)≥Gₐₜₕ, Gᵥ(n)≥Gᵥₜₕ, and R(n)≥Rₜₕ, reducing the pixel grayscale values of the n-th display area;
wherein the Gₐₜₕ is a threshold of the average value of the grayscale values;
wherein the Gᵥₜₕ is a threshold of the variance of the grayscale values;
wherein the Rₜₕ is a threshold of the root-mean-square-error of the grayscale values;
wherein n is a positive integer;
wherein when the current frame is the first frame being inputted, the grayscale value of the driving data of a pervious frame is set as 0.

3. The driving method of the display as claimed in claim 2, further comprising:
adjusting the pixel grayscale value of the n-th display area by the following formula:
G′ₚ(n)=f(n)×Gₚ(n);
wherein the Gₚ(n) is the pixel grayscale value before adjustment;
wherein the G′ₚ(n) is the pixel grayscale value after adjustment;
wherein the f(n) is an adjustment coefficient of the n-th display area;
wherein when Gₐ(n)≥Gₐₜₕ, Gᵥ(n)≥Gᵥₜₕ, R(n)≥Rₜₕ, 0<f(n)<1; otherwise f(n)=1.

4. The driving method of the display as claimed in claim 3, wherein when 0<f(n)<1, f(n) is a constant or an inversely proportional function related to the average value Gₐ(n).

5. The driving method of the display as claimed in claim 3, further comprising:
setting an adjustment threshold ΔG₀;
when a grayscale value difference ΔG=Gₚ(n)−f(n)×Gₚ(n)>ΔG₀, calculating the G′ₚ(n) by the following formula:
G′ₚ(n)=Gₚ(n)−ΔG₀.

6. The driving method of the display as claimed in claim 4, wherein the display areas comprises:
a central area, located on a central position of a displayed image;
a plurality of rim areas, located around the central area;
wherein a dimension of the central area is more than 50% of the dimension of the displayed image.

7. The driving method of the display as claimed in claim 5, wherein the display areas comprises:
a central area, located on a central position of a displayed image;
a plurality of rim areas, located around the central area;
wherein a dimension of the central area is more than 50% of the dimension of the displayed image.

8. A driving device of display devices, comprising:
an image input unit, configured to receive image data of each frames to be displayed in sequence;
an image analyzing unit, configured to divide the received image data of the frame into a plurality of display areas, and calculate pixel grayscale values of the display areas to determine adjustment coefficients of each of the display areas; wherein the adjustment coefficients of some of the or all of the display areas are configured to lower down the pixel grayscale values of the display areas;
an image processing unit, configured to adjust the pixel grayscale values of the display areas of a current frame according to the adjustment coefficients determined by the image analyzing unit, and combine all of the display areas after adjusting the pixel grayscale values to form driving data of the current frame;
an image output unit, configured to output the driving data of the current frame to drive the current frame to be displayed.

9. The driving device of the display as claimed in claim 8, wherein the image analyzing unit comprises:
a data saving module, configured to save a threshold of the average value of the grayscale values Gₐₜₕ, a threshold of the variance of the grayscale values Gᵥₜₕ, a threshold of the root-mean-square-error of the grayscale values Rₜₕ, and the driving data of a pervious frame;
an analyzing module, configured to divide the received image data of the frame into the plurality display areas, set all of sup-pixels of a n-th display area of the current frame as a set, calculate an average value Gₐ(n) of the grayscale values in the set, calculate a variance Gᵥ(n) of the grayscale values in the set, calculate a root-mean-square-error R(n) of the grayscale value of the current frame being relative to the grayscale value of the driving data of a pervious frame, and determine an adjustment coefficient f(n) of the n-th display area by comparing calculation values and thresholds; wherein n is a positive integer;
wherein when Gₐ(n)≥Gₐₜₕ, Gᵥ(n)≥Gᵥₜₕ, and R(n)≥Rₜₕ, the f(n) is determined to reduce the pixel grayscale value of the n-th display area;
wherein when the current frame is the first frame being inputted, the grayscale value of the driving data of a pervious frame saved in the data saving module is set as 0.

10. The driving device of the display as claimed in claim 9, wherein the image processing unit adjusts the pixel grayscale value of the n-th display area by the following formula:
G′ₚ(n)=f(n)×Gₚ(n);
wherein the Gₚ(n) is the pixel grayscale value before adjustment, the G′ₚ(n) is the pixel grayscale value after adjustment, and the f(n) is an adjustment coefficient of the n-th display area;
wherein when Gₐ(n)≥Gₐₜₕ, Gᵥ(n)≥Gᵥₜₕ, and R(n)≥Rₜₕ, 0<f(n)<1; otherwise f(n)=1.

11. The driving device of the display as claimed in claim 10, wherein when 0<f(n)<1, f(n) is a constant or an inversely proportional function related to the average value Gₐ(n).

12. The driving device of the display as claimed in claim 10, wherein the image processing unit set an adjustment threshold ΔG₀;
wherein when a grayscale value difference ΔG=Gₚ(n)−f(n)×Gₚ(n)>ΔG₀, the image processing unit calculates the G′ₚ(n) by the following formula:
G′ₚ(n)=Gₚ(n)−ΔG₀.

13. The driving device of the display as claimed in claim 11, wherein the display areas comprises:
a central area, located on a central position of a displayed image;
a plurality of rim areas, located around the central area;
wherein a dimension of the central area is more than 50% of the dimension of the displayed image.

14. The driving device of the display as claimed in claim 12, wherein the display areas comprises:
a central area, located on a central position of a displayed image;
a plurality of rim areas, located around the central area;
wherein a dimension of the central area is more than 50% of the dimension of the displayed image.

15. A display device, comprising a driving device and a display panel; wherein the driving device provides driving signals to the display panel to drive the display panel to display image; wherein the driving device comprises:
an image input unit, configured to receive image data of each frames to be displayed in sequence;
an image analyzing unit, configured to divide the received image data of the frame into a plurality of display areas, and calculate pixel grayscale values of the display areas to determine adjustment coefficients of each of the display areas; wherein the adjustment coefficients of some of the or all of the display areas are configured to lower down the pixel grayscale values of the display areas;
an image processing unit, configured to adjust the pixel grayscale values of the display areas of a current frame according to the adjustment coefficients determined by the image analyzing unit, and combine all of the display areas after adjusting the pixel grayscale values to form driving data of the current frame;
an image output unit, configured to output the driving data of the current frame to drive the current frame to be displayed.

16. The display as claimed in claim 15, wherein the image analyzing unit comprises:
a data saving module, configured to save a threshold of the average value of the grayscale values Gₐₜₕ, a threshold of the variance of the grayscale values Gᵥₜₕ, a threshold of the root-mean-square-error of the grayscale values Rₜₕ, and the driving data of a pervious frame;
an analyzing module, configured to divide the received image data of the frame into the multiple display areas, set all of sup-pixels of a n-th display area of the current frame as a set, calculate an average value Gₐ(n) of the grayscale values in the set, calculate a variance Gᵥ(n) of the grayscale values in the set, calculate a root-mean-square-error R(n) of the grayscale value of the current frame being relative to the grayscale value of the driving data of a pervious frame, and determine an adjustment coefficient f(n) of the n-th display area by comparing calculation values and thresholds; wherein n is a positive integer;
wherein when Gₐ(n)≥Gₐₜₕ, Gᵥ(n)≥Gᵥₜₕ, and R(n)≥Rₜₕ, the f(n) is determined to reduce the pixel grayscale value of the n-th display area;
wherein when the current frame is the first frame being inputted, the grayscale value of the driving data of a pervious frame saved in the data saving module is set as 0.

17. The display as claimed in claim 16, wherein the image processing unit adjusts the pixel grayscale value of the n-th display area by the following formula:
G′ₚ(n)=f(n)×Gₚ(n);
wherein the Gₚ(n) is the pixel grayscale value before adjustment, the G′ₚ(n) is the pixel grayscale value after adjustment, and the f(n) is an adjustment coefficient of the n-th display area;
wherein when Gₐ(n)≥Gₐₜₕ, Gᵥ(n)≥Gᵥₜₕ, and R(n)≥Rₜₕ, 0<f(n)<1; otherwise f(n)=1.

18. The display as claimed in claim 17, wherein when 0<f(n)<1, f(n) is a constant or an inversely proportional function related to the average value Gₐ(n).

19. The display as claimed in claim 17, wherein the image processing unit set an adjustment threshold ΔG₀;
wherein when a grayscale value difference ΔG=Gₚ(n)−f(n)×Gₚ(n)>ΔG₀, the image processing unit calculates the G′ₚ(n) by the following formula:
G′ₚ(n)=Gₚ(n)−ΔG₀.

20. The display as claimed in claim 18, wherein the display areas comprises:
a central area, located on a central position of a displayed image;
a plurality of rim areas, located around the central area;
wherein a dimension of the central area is more than 50% of the dimension of the displayed image.
